(19) United States
(12) Patent Application Publication
(10) Pub. No.: US 2026/0260291 A1
(43) Pub. Date: Sep. 3, 2026

(54) Anonymous Life Settlement Transaction Ecosystem

(71) Applicant: Stephen Jass, Mount Dora, FL (US)

(72) Inventor: Stephen Jass, Mount Dora, FL (US)

(73) Assignee: Life Settlement Hub LLC, Oldsmar, FL (US)

(21) Appl. No.: 19/066,261

(22) Filed: Feb. 28, 2025

(51) Int. Cl. G06Q 40/04; G06F 21/62; G06Q 40/08

(52) U.S. Cl. CPC G06Q 40/04; G06Q 40/08

(57) ABSTRACT

A comprehensive ecosystem and method anonymously processes life insurance policies in life settlement transactions by transforming them into digital assets at any stage, enabling secondary transactions where policy owners sell for monetary value, retained death benefits, or combinations thereof. Investors fund policies individually or collectively using any medium (e.g., cash, cryptocurrency) across centralized, decentralized, or hybrid frameworks, with tertiary market trading supported. It integrates diverse premium payment structures—periodic contributions, embedded reserves, third-party guarantees, fractional ownership, annuities, and more—with privacy options: full disclosure or anonymity until specified events (e.g., death, lapse). A securities intermediary and maintenance entity enforce anonymity via restricted access protocols, managing the lifecycle from creation through funding, trading, compliance, auditing, and redemption. Features include dynamic privacy adjustments, multi-policy coordination, external integration, alternative revenue (e.g., mortality derivatives), and lifecycle extension, ensuring adaptability, security, and anonymity against all workarounds, maximizing investor flexibility and market value realization.

In traditional life settlement transactions, as exemplified by prior art such as U.S. Pat. No. 8,285,569 B2, titled ‘System for Facilitating Life Settlement Transactions,’ issued Oct. 9, 2012, to Spalding, the sale of a life insurance policy necessitates full disclosure of the insured's identity to all owning entities, whether through secondary transactions—where the policy owner sells their policy—or subsequent tertiary market trades. This mandatory disclosure, inherent in systems like Spalding's web-based auction platform, links the insured's identity to a financial incentive tied to their mortality, as investors benefit from the death benefit upon the insured's passing, creating substantial privacy and safety risks for the insured. Existing systems, including Spalding's, lack mechanisms to preserve insured anonymity while enabling policy owners to realize the full market value of their policies, typically relying on conventional sales without transforming policies into digital assets or offering flexible funding and trading options across their lifecycle. Other prior art, such as tokenization systems (e.g., U.S. Pat. No. 8,751,379 B2, ‘System and Method for Managing Digital Assets,’ issued Jun. 10, 2014, to Siegel et al.), crowdfunding platforms (e.g., U.S. Pat. No. 7,885,887 B2, ‘Methods and Apparatuses for Financing and Marketing a Creative Work,’ issued Feb. 8, 2011, to Boone et al.), and blockchain frameworks (e.g., U.S. Pat. No. 10,346,779 B2, ‘Systems and Methods for Managing Digital Assets Using a Distributed Ledger,’ issued Jul. 9, 2019, to Atkins et al.), fails to address these privacy risks or integrate a cohesive ecosystem that balances anonymity with comprehensive lifecycle management, diverse premium structures, and collective investment capabilities specific to life settlements.

The absence of privacy-preserving mechanisms in prior systems limits policy owners' ability to mitigate risks associated with identity disclosure while maximizing economic value, as investors traditionally require full personal information to assess mortality-based returns, a practice that Spalding's system reinforces with its open database and tracking features (e.g., FIG. 8). Additionally, existing methods do not support tokenization at arbitrary stages, collective funding via smart contract pools across decentralized networks, or robust auditing to ensure operational integrity without compromising anonymity, leaving a significant gap in the life settlement industry. This invention addresses this overarching problem by providing a comprehensive ecosystem that transforms life insurance policies into digital assets at any point, offers both high market offers with full disclosure and high anonymous offers preserving insured identity until death or pre-death events (e.g., policy lapse), and integrates a full range of funding and trading options. Together, these components work cohesively to maintain the anonymity of policyholders while maximizing liquidity and expanding investment opportunities. None of these elements independently solve the problem; only their integration can ensure privacy, compliance, and operational efficiency.

### BRIEF SUMMARY OF THE INVENTION

The present invention provides an ecosystem and method for processing life insurance policies within life settlement transactions by transforming them into digital assets at any stage—before, during, or after secondary transactions—wherein a policy owner sells their policy for consideration encompassing any form of monetary value, retained death benefit portions, or hybrid combinations, with investors funding these assets individually or collectively through any medium, including cash, cryptocurrency, or alternative assets, operable across any technological framework—centralized systems, decentralized networks, hybrid configurations, or emerging platforms. The ecosystem facilitates secondary transactions with configurable privacy options, allowing investors to submit offers requiring full disclosure for high market offers or preserving absolute anonymity until specified events (e.g., insured's death or pre-death conditions like policy lapse) for high anonymous offers, and supports tertiary market trading with identical purchase options, ensuring seamless liquidity and flexibility.

For anonymous offers, a securities intermediary assumes ownership, shielding insured identity from investors, while a maintenance entity manages premium payments, insured updates, and data access with stringent restricted protocols, ensuring investor information remains anonymized unless a predefined pre-death event triggers disclosure, thereby eliminating privacy risks inherent in traditional systems. The ecosystem integrates an exhaustive array of premium payment structures—periodic contributions, embedded reserves, third-party guarantees, performance-linked adjustments, fractional ownership with variable tiers, self-funding from policy revenue streams, convertible payment models, community-pooled reserves across multiple policies, time-limited obligations, and annuities linked to the insured's lifecycle—providing unmatched funding versatility managed by the maintenance entity.

Advanced features include dynamic privacy adjustments during the lifecycle, multi-policy coordination for concurrent processing, integration with external systems for enhanced operations, alternative revenue generation through policy-derived streams (e.g., mortality derivatives), and lifecycle extension via renewal or re-tokenization, all supported by robust compliance adaptable to any regulatory environment and auditing to verify operational integrity without breaching anonymity. The ecosystem manages the full transaction lifecycle—from digital asset creation through secondary transaction initiation, funding coordination, tertiary market trading, compliance, auditing, and redemption—delivering a comprehensive, privacy-preserving framework that ensures maximum flexibility, security, and operational resilience, rendering all conceivable workarounds ineffective by protecting insured anonymity and enabling optimal market value realization across centralized, decentralized, or hybrid infrastructures.

These components are designed to operate as an interconnected system, where each element supports the others to achieve a level of privacy, efficiency, and regulatory compliance not possible in isolated solutions. By addressing privacy, security, and market accessibility as a single, unified problem, this invention creates a scalable and sustainable framework for modern life settlement transactions.

### BRIEF DESCRIPTION OF THE DRAWINGS

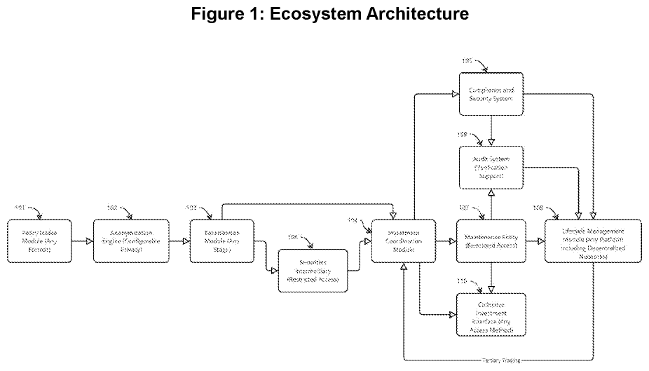

### FIG. 1: Ecosystem Architecture

FIG. 1 presents the ecosystem architecture of the Privacy-Preserving Life Settlement Transaction Ecosystem as a schematic layout, offering a comprehensive depiction of the interconnected components that collectively enable the secure, adaptable, and privacy-centric processing of life insurance policies within life settlement transactions. This figure outlines the operational workflow from the receipt of policy-related data through its transformation into a tradable digital asset, funding by one or more investors, coordination across various transactional phases, verification of operational integrity, and overarching lifecycle management. The architecture facilitates the conversion of life insurance policies into digital representations, supports funding through any medium—such as cash, cryptocurrency, retained benefit portions, or combinations thereof—and provides configurable privacy options ranging from full anonymity preserved until specified events (e.g., death or pre-death conditions) to optional disclosure, all managed by entities ensuring security, compliance, and integrity across any technological framework or operational environment.

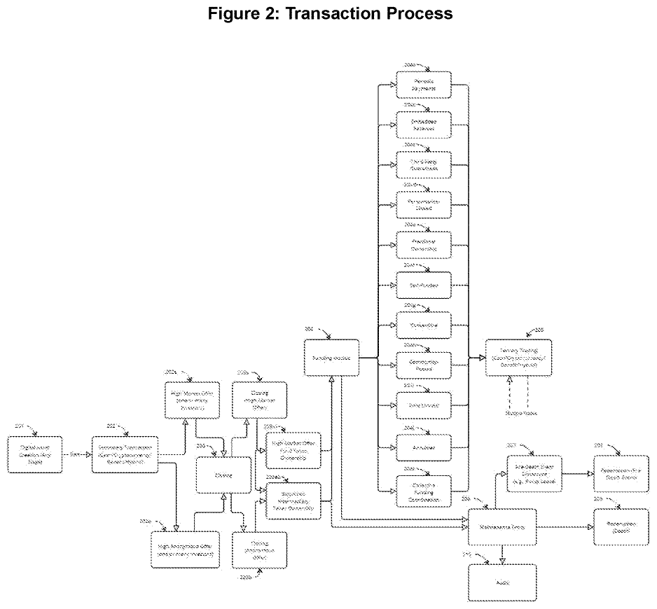

### FIG. 2: Transaction Process

FIG. 2 illustrates the transaction process of the Privacy-Preserving Life Settlement Transaction Ecosystem as a timeline, comprehensively depicting the sequence from the creation of a digital asset representing a life insurance policy through secondary transactions, policy closing, funding, tertiary trading, maintenance, auditing, and redemption within life settlement transactions. This figure provides a detailed visual representation of the ecosystem's operational flow, demonstrating how one or more investors can fund policies using any form of value-such as cash, cryptocurrency, retained benefit portions, or combinations thereof-either individually or collectively through a coordinated platform, and how the system ensures configurable privacy preservation or traditional disclosure based on the selected offer type. The process commences with the tokenization of the policy into a digital asset, advances through investor offers and ownership transfer, incorporates funding coordination, maintenance, and auditing phases, and concludes with redemption triggered by the insured's death or specified pre-death events, supporting both decentralized network operations and collective investment capabilities.

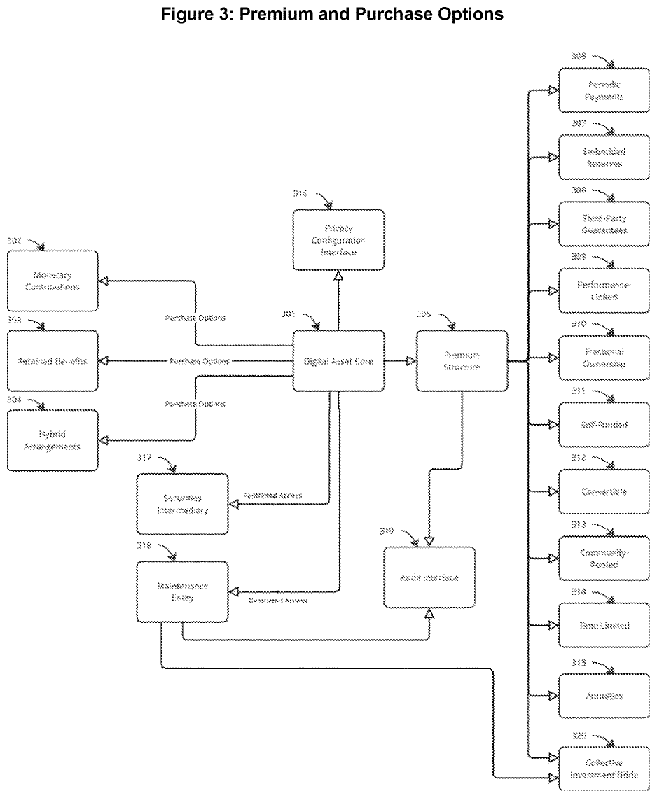

### FIG. 3: Premium and Purchase Options

FIG. 3 illustrates the premium and purchase options within a digital asset of the Privacy-Preserving Life Settlement Transaction Ecosystem, presenting a schematic layout that encapsulates the diverse funding mechanisms and acquisition options embedded in the asset's structure, alongside configurable privacy settings and entities enforcing ownership and data access controls. This figure delineates the versatility of the digital asset, representing a tokenized life insurance policy for life settlement transactions, by detailing a comprehensive array of funding structures and purchase modalities accessible at any stage of tokenization-before, during, or after transactional activities. The schematic highlights the ecosystem's capacity to support a broad spectrum of funding arrangements and ownership configurations, ensuring flexibility for investors while maintaining robust privacy or disclosure options as determined by the transaction type.

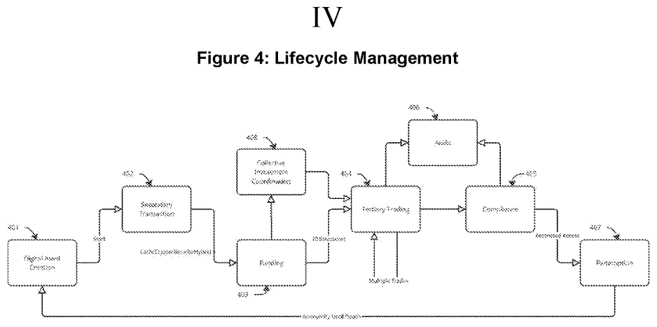

### FIG. 4: Lifecycle Management

FIG. 4 delineates the lifecycle management of the Privacy-Preserving Life Settlement Transaction Ecosystem as a cyclical diagram, illustrating the comprehensive progression of a digital asset—representing a life insurance policy for life settlement transactions—from its inception through funding, collective investment coordination, trading, compliance verification, auditing, and redemption. This figure encapsulates the ecosystem's operational flow, showcasing its capacity to manage assets funded by one or more investors via any medium-such as cash, cryptocurrency, retained benefit portions, or combinations thereof-individually or collectively, across any transactional phase or operational context. The cycle integrates configurable privacy settings, enabling full anonymity preserved until specified events (e.g., death or pre-death conditions) or optional disclosure, supported by entities ensuring security, compliance, and operational integrity, adaptable to any technological framework or platform, including decentralized networks.

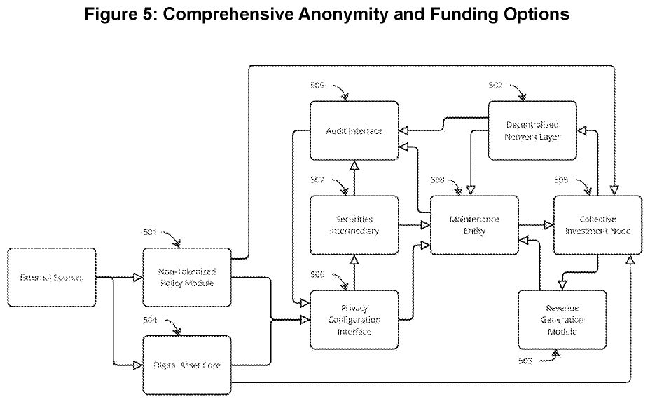

### FIG. 5: Comprehensive Anonymity and Funding Options

FIG. 5 illustrates the comprehensive anonymity and funding options of the Privacy-Preserving Life Settlement Transaction Ecosystem as a schematic layout, depicting the parallel processing of life insurance policies as digital assets or non-tokenized entities within life settlement transactions. This figure delineates the ecosystem's ability to manage policies funded by one or more investors through any medium, including cash, cryptocurrency, or alternative assets, individually or collectively via decentralized networks or centralized systems. It integrates configurable privacy settings—maintaining anonymity until specified events or enabling disclosure—alongside diverse funding structures and revenue generation options, supported by entities ensuring security, compliance, and integrity across all operational frameworks.

### DETAILED DESCRIPTION OF THE INVENTION

The invention provides a comprehensive ecosystem and method for processing life insurance policies in a privacy-preserving manner, transforming them into anonymized digital assets at any stage—before, during, or after secondary transactions—and facilitating their sale and subsequent trading across secondary and tertiary markets. Policy owners sell their policies to one or more investors for an amount of cash, cryptocurrency, a retained death benefit portion, or a hybrid of these options, with funding occurring individually or collectively. The ecosystem integrates ten diverse premium payment structures and offers robust privacy options: high market offers requiring full disclosure and high anonymous offers preserving insured anonymity until death or specified pre-death events (e.g., policy lapse), supported by a securities intermediary and a maintenance company with restricted data access. Operating across any technological framework—centralized, decentralized, or hybrid—the system manages the full transaction lifecycle from digital asset creation to redemption, ensuring flexibility, compliance, and resilience. The following detailed description, in conjunction with the accompanying figures, elucidates the ecosystem's architecture, transaction process, asset structure, and lifecycle management.

FIG. 1 illustrates the ecosystem architecture of the Privacy-Preserving Life Settlement Transaction Ecosystem as a schematic layout, providing a comprehensive overview of the interconnected components that collectively enable the secure, adaptable, and privacy-centric processing of life insurance policies within life settlement transactions. This figure delineates the operational workflow from the receipt of policy-related data through its transformation into a tradable digital asset, funding by one or more investors, coordination of collective investment and transactions, auditing for operational integrity, and lifecycle management across diverse platforms, including decentralized networks. The architecture supports the conversion of life insurance policies into digital representations, facilitates funding through any medium-such as cash, cryptocurrency, retained benefit portions, or combinations thereof- and ensures configurable privacy options ranging from full anonymity preserved until specified events (e.g., death or pre-death conditions) to optional disclosure, all managed by entities designed for security, compliance, and validation across any technological framework or operational environment.

The ecosystem begins with the Policy Intake Module (101), which receives life insurance policy data from any source—such as policy owners, agents, or other stakeholders—in any format, ensuring broad accessibility for initiating life settlement transactions. The Anonymization Engine (102) processes this data to configure privacy levels, anonymizing insured identity information as required to maintain anonymity or enable disclosure based on the transaction's needs. The Anonymization Engine (102) may also process policy data in an ephemeral state, temporarily handling anonymized information for valuation or transaction purposes and purging it after completion to eliminate traceability, further enhancing privacy protection. The Tokenization Module (103) transforms the policy into a digital asset at any stage, embedding funding mechanisms, privacy settings, and transactional attributes to create a versatile entity for settlement activities. The Securities Intermediary (106) manages ownership, securing anonymous transactions by restricting investor access to insured identity, with flexibility to support disclosed configurations as needed.

Funding and transactional coordination are facilitated by the Investment Coordination Module (104), which integrates resources from one or more investors, individually or collectively, across any medium, enabling both initial sales and subsequent trades. The Collective Investment Interface (110) enhances this process by providing a platform for coordinating collective investment, allowing investors to access, fund, and trade policies collaboratively through any interface or decentralized network, ensuring efficient resource pooling and management. The Compliance and Security System (105) enforces adherence to regulatory and operational standards while securing ecosystem assets, collaborating with other components to maintain integrity.

The Maintenance Entity (107) oversees premium payments, insured updates, and data management, restricting access to sensitive information to preserve anonymity or provide disclosed data as required, ensuring operational continuity within a safeguarded framework. The Audit System (109) verifies the Maintenance Entity's operations or the digital asset's validity, employing any method to ensure compliance and accuracy without compromising anonymity until disclosure is necessitated, integrating seamlessly with compliance and maintenance efforts. The Lifecycle Management Module (108) orchestrates the entire process, managing the digital asset's lifecycle—from creation through funding, collective investment coordination, trading, auditing, and redemption—across any platform, including decentralized networks, to deliver a robust life settlement ecosystem.

The ecosystem optionally provides anonymous valuation services, assessing policy value using anonymized data (e.g., actuarial metrics) via the Anonymization Engine (102), enabling policy owners to evaluate market potential without offers or identity disclosure, as supported by the Privacy Configuration Interface (506).

FIG. 2 illustrates the transaction process of the Privacy-Preserving Life Settlement Transaction Ecosystem as a timeline, depicting the sequence from the creation of a digital asset representing a life insurance policy through secondary transactions, policy closing, funding, tertiary trading, maintenance, auditing, and redemption within life settlement transactions. This figure delineates the ecosystem's operational flow, showcasing how one or more investors can fund policies using any form of value—such as cash, cryptocurrency, retained benefit portions, or combinations thereof—individually or collectively, and how the system supports configurable privacy levels ranging from full anonymity until specified events to optional disclosure. The process integrates tokenization, investor offers, ownership transfer, collective funding coordination, maintenance, auditing, and redemption, adaptable to any operational framework including decentralized networks, ensuring privacy preservation and operational integrity across the lifecycle.

The process begins with Digital Asset Creation (201), where a life insurance policy is transformed into a digital asset via the Tokenization Module (103) at any stage of its lifecycle, embedding premium payment structures and privacy configurations for flexible integration into life settlement transactions. This advances to Secondary Transaction (202), where the policy owner solicits offers from investors, supporting a default High Anonymous Offer—preserving insured identity anonymity until specified events—or an optional High Market Offer disclosing identity upon acceptance, with funding terms established accordingly. Closing (203) transfers ownership to the Securities Intermediary (106) for anonymous offers or alternative entities for disclosed offers, securing the transaction's structure.

Funding Models (204) facilitates the application of premium payment structures, overseen by the Maintenance Entity (107), enabling investors to sustain policy obligations individually or collectively. This includes Collective Funding Coordination (204k), where contributions are aggregated, premiums are managed, and returns are distributed among investors, supported by a platform accessible via decentralized networks or other frameworks, enhancing collaborative investment capabilities. Tertiary Trading (205) allows subsequent exchanges of the digital asset among investors, maintaining privacy and funding terms across any platform, including decentralized systems. Additionally, the Funding Models (204) may incorporate secure escrow services to manage and release funds between policy owners and investors, ensuring transactional security and compliance with privacy-preserving protocols.

Maintenance (206) ensures ongoing management of premiums and insured updates, restricting identity access for anonymous offers or providing disclosed data as needed, executed by the Maintenance Entity (107). Audit (210) verifies the Maintenance Entity's operations or the digital asset's integrity, employing any method to ensure compliance and accuracy while preserving anonymity until disclosure is required. The process concludes with Pre-Death Event Disclosure (207), triggering identity release for anonymous offers if specified events occur, followed by Redemption—Pre-Death (208) for early resolution, or Redemption—Death (209) for final profit allocation upon the insured's death, managed by the Securities Intermediary (106) and Maintenance Entity (107) to uphold privacy commitments.

FIG. 3 illustrates the premium and purchase options embedded within a digital asset of the Privacy-Preserving Life Settlement Transaction Ecosystem, presenting a schematic layout that encapsulates a diverse array of funding mechanisms and acquisition modalities, alongside configurable privacy settings, ownership management, operational oversight, collective investment coordination, and an auditing interface to ensure integrity. This figure delineates the adaptability of the digital asset, representing a tokenized life insurance policy for life settlement transactions, by detailing an extensive spectrum of funding structures and purchase options accessible at any stage of tokenization—before, during, or after transactional activities. The schematic highlights the ecosystem's capacity to support a wide range of funding arrangements, ownership configurations, and privacy preferences, underpinned by a modular framework that integrates collective investment and auditing to validate operational accuracy and asset validity, adaptable to any operational context or technological platform.

The Digital Asset Core (301) forms the central entity, representing a tokenized life insurance policy created via the Tokenization Module (103) at any stage, embedded with versatile purchase and funding attributes that define its transactional potential within life settlement activities. Investors acquire this asset through Purchase Options, including Monetary Contributions (302) utilizing any form of value such as cash or cryptocurrency, Retained Benefits (303) preserving a portion of the policy's death benefit for the seller, and Hybrid Arrangements (304) combining monetary and benefit terms for flexible acquisition.

The Premium Structure Node (305) consolidates a broad collection of funding mechanisms to sustain the policy's premium obligations, supporting options such as periodic payments, annuities, or self-funding models, adaptable to diverse investor needs. The Collective Investment Node (320) enables coordinated funding among multiple investors, facilitating resource pooling and collective management of premium payments and returns, accessible via any platform including decentralized networks, enhancing the ecosystem's collaborative investment capabilities.

The Privacy Configuration Interface (316) manages privacy settings, enabling configurations from full anonymity—preserving the insured's identity until specified events like death or pre-death conditions—to full disclosure, supporting the ecosystem's default high anonymous offers or optional high market offers. The Securities Intermediary (317) secures ownership, restricting investor access to sensitive data for anonymous transactions or optionally managing disclosed assets, ensuring transactional versatility.

The Maintenance Entity (318) oversees funding obligations and policy updates, maintaining operational integrity by restricting access to insured identity for anonymous offers or providing disclosed data as needed, interfacing securely with external sources. The Audit Interface (319) verifies the Maintenance Entity's operations and funding data validity, employing any method to ensure accuracy and compliance while preserving privacy until disclosure is required, integrating seamlessly with the ecosystem's structure.

FIG. 4 illustrates the lifecycle management of the Privacy-Preserving Life Settlement Transaction Ecosystem as a cyclical process encompassing the creation, funding, collective investment coordination, trading, compliance, auditing, and redemption of a digital asset representing a life insurance policy within life settlement transactions. The figure delineates the ecosystem's ability to transform and manage assets funded by one or more investors through diverse mediums, including cash, cryptocurrency, retained benefit portions, or combinations thereof, across any transactional phase or operational context. It integrates configurable privacy settings—supporting full anonymity until specified events or optional disclosure—managed by entities ensuring security, compliance, and operational integrity, adaptable to any technological framework, including decentralized networks.

The lifecycle begins with Digital Asset Creation (401), where the Tokenization Module (103) converts a life insurance policy into a digital entity at any stage, embedding funding mechanisms, transactional attributes, and privacy configurations to enable seamless integration into the ecosystem. This advances to Secondary Transaction (402), where the policy owner initiates the sale to investors, who may select a high anonymous offer preserving insured identity privacy or an optional high market offer disclosing identity if enabled, establishing funding terms for subsequent phases.

Funding (403) oversees the application of premium payment structures, utilizing a broad range of mechanisms to sustain the asset's obligations, managed by the Maintenance Entity (107). Collective Investment Coordination (408) facilitates collaborative funding among investors, aggregating contributions and managing premium payments and returns, accessible via any platform including decentralized networks, enhancing collective investment capabilities. Tertiary Trading (404) supports ongoing asset exchanges among investors, maintaining funding and privacy terms, overseen by the Securities Intermediary (106) for ownership management across anonymous or disclosed configurations.

Compliance (405) ensures adherence to regulatory and operational standards, securing assets and verifying processes in collaboration with the Securities Intermediary (106) and Maintenance Entity (107), upholding privacy or enabling disclosure as required. Audit (406) verifies the Maintenance Entity's operations or the digital asset's data integrity, conducted by any entity or method, ensuring accuracy while preserving anonymity through restricted access protocols, coordinated with the Securities Intermediary (106) and Maintenance Entity (107). The cycle concludes at Redemption (407), where profit allocation occurs upon the insured's death or a pre-death event, managed by the Securities Intermediary (106) and Maintenance Entity (107), revealing identity only at specified endpoints for anonymous offers or utilizing disclosed data for market offers, with the process capable of restarting for new assets.

FIG. 5 illustrates the Comprehensive Anonymity and Funding Options. The process commences with the Non-Tokenized Policy Module (501), which enables the management of life insurance policies in their physical or non-digital form, receiving policy-related data from any source—such as policy owners, agents, or third-party entities—in formats like paper documents or encrypted non-tokenized digital records. This module integrates non-tokenized policies into the ecosystem, anonymizing insured identity information through mechanisms such as trustee-managed blind trusts, legal proxies, or physical record encryption, ensuring privacy preservation without requiring digital transformation, as supported by any entity or method adaptable to life settlement needs (claims 29, 31, 34). It interfaces with other components to facilitate funding and ownership transfers, providing a parallel pathway to digital asset processing and ensuring comprehensive coverage across all policy formats.

In parallel, the Digital Asset Core (504) represents the tokenized form of a life insurance policy, transformed at any stage—before, during, or after life settlement transactions—via the Tokenization Module (103), embedding premium payment structures, transactional attributes, and privacy configurations as delineated in claims 1 and 13. This core integrates funding and purchase options, enabling investors to acquire the digital asset through monetary contributions (e.g., cash, cryptocurrency), retained death benefit portions, or hybrid combinations (claims 1, 3), processed through any operational framework, including decentralized networks (claims 17, 22). The dual pathways from the Non-Tokenized Policy Module (501) and Digital Asset Core (504) converge to support the ecosystem's full range of transactional capabilities, ensuring flexibility for both digital and non-digital policy management.

The Decentralized Network Layer (502) facilitates the execution of transactions, funding, and privacy management processes across distributed ledgers or peer-to-peer systems, employing consensus mechanisms such as proof-of-stake or proof-of-work to validate operations, as specified in claims 22 and 32. This layer supports blockchain-based smart contracts (e.g., Ethereum ERC-20 tokens) for collective investment coordination (claims 21, 24) and integrates with external blockchain oracles or data sources (claim 26) to enhance real-time funding adjustments (claim 36) and policy updates, providing a secure and scalable infrastructure for managing digital assets and ensuring anonymity through cryptographic techniques like zero-knowledge proofs (claim 35). It connects to both tokenized and non-tokenized pathways, enabling seamless operation across all frameworks.

The Revenue Generation Module (503) enables the digital asset or non-tokenized policy to generate value or sustain obligations through any revenue model (e.g., “mortality swaps via exchanges”) derived from life insurance policies, including derivative transactions such as mortality swaps traded on exchanges, policy-linked proceeds like collateralized loans, or premium offsets via revenue streams (claim 27). Managed by an entity within the ecosystem, this module ensures funding versatility beyond traditional premium structures, integrating with the Digital Asset Core (504) for tokenized policies and the Non-Tokenized Policy Module (501) for physical policies, providing a comprehensive economic framework that supports lifecycle extension through renewal or restructuring (claim 28).

The Collective Investment Node (505) facilitates coordinated funding among multiple investors, aggregating contributions, managing premium payments, and distributing returns, accessible via any interface—including blockchain-based interfaces—or decentralized network framework (claims 21, 23, 24). This node employs smart contract mechanisms or centralized pooling to allocate resources and validate transactions (claim 32), interfacing with the Decentralized Network Layer (502) for blockchain-supported operations and the Premium Structure Node (305) for diverse funding options (claims 3-12), such as periodic contributions, annuities, or fractional ownership with variable tiers. It ensures that collective investment operates seamlessly alongside individual funding, enhancing the ecosystem's scalability for multi-policy coordination (claim 25).

The Privacy Configuration Interface (506) governs privacy settings for both digital and non-tokenized policies, enabling configurations ranging from full anonymity—preserving insured identity until any predefined policy-related or lifecycle event (e.g., death, policy lapse, surrender, default, renewal)—to full disclosure, as dictated by the ecosystem's dual-offer framework of high anonymous offers or optional high market offers (claims 1, 2, 14, 15, 20). This interface supports dynamic privacy adjustments based on transactional needs or external conditions (claim 20), employing cryptographic safeguards like homomorphic encryption (claim 35) or non-cryptographic blinding (claim 30) to enforce anonymity, ensuring that investor access to insured identity remains restricted until specified disclosure events.

The Securities Intermediary (507) manages ownership across all configurations, securing anonymous transactions by restricting investor access to sensitive data via restricted access protocols (claims 13-15), whether for tokenized digital assets or non-tokenized policies. It collaborates with the Maintenance Entity (508) to ensure seamless ownership transfers and compliance with privacy settings, adaptable to both high anonymous and high market offer scenarios, providing a robust backbone for transaction integrity.

The Maintenance Entity (508) oversees premium payments, insured updates, and data management for both digital and non-tokenized policies, maintaining operational continuity within a restricted access framework that safeguards privacy or provides disclosed data as needed (claims 14-16). It interfaces securely with external systems (claim 26) to retrieve real-time data (e.g., insured health status) and supports funding obligations through diverse premium structures, ensuring compliance and asset integrity across all lifecycle phases.

The Audit Interface (509) verifies the integrity of the ecosystem's operations—including the Maintenance Entity's activities, funding data validity, and policy status—across both digital and non-tokenized pathways, employing any method such as automated blockchain verification or manual assessments (claim 19). It preserves configured privacy levels through restricted access protocols, ensuring compliance adapts to any regulatory environment (claim 16) and operational accuracy is maintained without compromising anonymity until disclosure is required, integrating seamlessly with all ecosystem components.

1. A system for conducting privacy-preserving life settlement transactions, comprising:
A secure data registry system configured to represent life insurance policies as unique digital assets or non-tokenized entities, wherein the secure data registry system includes centralized databases, distributed ledgers with consensus mechanisms such as proof-of-stake, or hybrid frameworks;
An anonymization engine configured to:
Obscure or remove all personally identifiable information (PII) related to the policy owner and/or insured individual at any point before, during, or within the ecosystem;
Implement one or more privacy-preserving techniques selected from the group consisting of manual redaction, pseudonymization, encryption, tokenization, secure multi-party computation, homomorphic encryption, differential privacy, or equivalent methods;
Maintain anonymization throughout the policy's lifecycle until specified events, including death, policy lapse, surrender, default, or other predefined policy-related conditions, or enable disclosure.

2. The system of claim 1, further comprising an investor interface configured to:
Enable investors to view and evaluate anonymized policy assets;
Facilitate bidding and acquisition without revealing insured identity;
Support individual or collective investment, including fractional ownership, via smart contract mechanisms.

3. The system of claim 1, further comprising a compliance and verification module configured to:
Verify authenticity and validity via privacy-preserving processes;
Enforce KYC and AML compliance without compromising anonymity;
Validate pre-anonymized policies before integration;
Interface with external systems such as blockchain oracles for enhanced operations.

4. The system of claim 1, further comprising a secure escrow and payment system configured to:
Manage fund transfers between sellers and investors using any form of value;
Release payments upon transaction milestones;
Ensure escrow compliance with privacy.

5. The system of claim 1, wherein anonymizing identifiable insured information includes any technique for concealing or securing data, such as encryption, pseudonymization, or zero-knowledge proofs, configurable to maintain anonymity until specified events or enable disclosure, with access managed by an entity providing updates to investors while restricting insured identity exposure through restricted access protocols.

6. The system of claim 1, wherein transforming the life insurance policy into a digital asset occurs at any point relative to life settlement transactions, with ownership assigned to a securities intermediary for anonymity-preserving configurations using restricted access protocols.

7. The system of claim 1, wherein life settlement transactions include investor offers configurable for full disclosure of insured identity or anonymity until any predefined policy-related or lifecycle event, managed by a securities intermediary taking ownership and a maintenance entity restricting access to insured identity via cryptographic or physical safeguards while providing anonymized updates, funded by one or more investors using any form of value.

8. The system of claim 1, wherein tertiary market trading of life insurance policies allows transactions using any form of value or benefit terms by one or more investors, with anonymity preserved until any predefined policy-related or lifecycle event via a maintenance entity enforcing restricted access protocols.

9. The system of claim 1, wherein compliance with life settlement regulations is ensured through verification processes adaptable to any standards, with a maintenance entity managing privacy protocols across all stages and disclosure events via secure compliance mechanisms.

10. The system of claim 1, wherein the operational framework encompasses any system, platform, or methodology, including centralized databases, decentralized networks with distributed ledgers, or hybrid systems, for processing and managing life insurance policies within life settlement transactions, facilitating collective investment.

11. A system comprising a processor and memory configured to execute the system of claim 1 for processing life insurance policies in life settlement transactions, deployable across any infrastructure or operational environment, including decentralized networks with blockchain protocols.

12. The system of claim 1, further comprising auditing the digital asset or its management processes to ensure validity or operational integrity within life settlement transactions, conducted by any entity or method, including automated blockchain verification, while preserving configured privacy levels via restricted access protocols.

13. The system of claim 1, wherein privacy configurations for life insurance policies are dynamically adjustable during the asset's lifecycle based on transactional needs, investor preferences, or external conditions, managed by a maintenance entity enforcing restricted access to insured identity via cryptographic safeguards.

14. The system of claim 1, wherein enabling one or more investors to fund the digital asset collectively includes providing a platform for coordinating collective investment in life insurance policies, accessible via any interface or decentralized network, facilitating resource pooling among investors through smart contract mechanisms.

15. The system of claim 1, wherein managing the digital asset across its lifecycle utilizes decentralized networks, including distributed ledgers or peer-to-peer systems with consensus mechanisms such as proof-of-stake, to execute transactions, funding, or privacy management processes.

16. The system of claim 14, wherein the platform includes a user interface enabling investors to access, fund, or trade life insurance policies, configurable for operation across any device or decentralized network framework, including blockchain-based interfaces.

17. The system of claim 1, further configured to anonymously assess and provide a valuation of a life insurance policy for life settlement purposes without facilitating offers or transactions, maintaining insured anonymity via the anonymization engine throughout the valuation process.

18. A method for anonymously assessing and providing a valuation of a life insurance policy for life settlement purposes without facilitating offers or transactions, comprising:
Receiving pre-anonymized or anonymized policy data from a policy owner, external entity, or third-party service;
Processing the anonymized data using actuarial models, predictive analytics, or AI-based valuation tools;
Generating and providing a valuation to the policy owner or authorized entity while maintaining the anonymity of the policy owner and/or insured individual throughout the process.

19. The system of claim 1, wherein anonymization of personally identifiable information (PII) related to the policy owner and/or insured individual is achieved through one or more defined methods, including but not limited to cryptographic techniques using encryption protocols such as homomorphic encryption, zero-knowledge proofs, or blockchain-based hashing to prevent unauthorized disclosure of PII during data transmission, valuation, or transaction phases; algorithmic anonymization implementing AI-driven protocols, including machine learning models trained to detect and obfuscate identifiable data patterns, while maintaining data integrity for valuation and risk assessment; manual and non-cryptographic methods including manual redaction, data masking, or pseudonymization for handling physical documents or systems where cryptographic methods are impractical; adaptive anonymization utilizing dynamic methods that adjust privacy levels based on transaction type, user access level, or external conditions, ensuring compliance with jurisdictional privacy regulations; and a future-proofing clause whereby the system supports the integration of future anonymization methods developed post-patent issuance, provided they serve the core function of obscuring PII in life settlement transactions.

20. A system according to claim 1, further configured to integrate with external platforms, broker networks, or third-party services while maintaining insured anonymity, comprising:
Transmitting anonymized policy data to external systems for valuation, bidding, or transaction facilitation;
Receiving and processing data from external platforms while ensuring privacy standards remain intact;
Enforcing anonymization protocols during all third-party interactions.

21. The system of claim 1, wherein artificial intelligence (AI) and machine learning algorithms are utilized to:
Optimize anonymization processes by dynamically adapting privacy parameters based on potential de-anonymization risks;
Enhance policy valuation using historical data, predictive models, or real-time market analysis;
Improve fraud detection and risk analysis within anonymized datasets.

22. A user interface integrated into the system of claim 1, designed for policy owners or authorized representatives, comprising secure portals for uploading policy documents and associated data, automatically anonymized upon entry into the system using encryption and data masking protocols; interactive dashboards that allow policy owners to view real-time valuation updates, investor activity, and market trends while maintaining full identity protection; encrypted messaging and inquiry systems enabling policy owners to communicate with brokers, investors, or third parties without disclosing personal details; automated alerts for policy milestones (e.g., valuation changes, offer submissions, transaction status) delivered via anonymized channels such as secure in-app notifications or encrypted emails; and configurable privacy levels that allow policy owners to adjust data visibility during different stages of valuation or transactions, with options for selective disclosure if desired.

23. The system of claim 1, wherein the anonymization engine is capable of processing policy data that has been anonymized by external entities, including:
Verifying the integrity of pre-anonymized data to ensure compliance with privacy standards;
Accepting pre-anonymized data from policy owners, agents, or third-party services without further modification to anonymization protocols;
Continuing the anonymized process within the ecosystem.

24. The system of claim 1, configured to process policy data in a temporary or ephemeral state, wherein:
Data is processed for valuation or transaction purposes without long-term storage;
Anonymized data is purged after completion of the process, eliminating traceability;
The insured's identity remains undisclosed during and after ephemeral data handling.

25. The system of claim 1, wherein the anonymization engine is further configured to optionally maintain anonymization of the insured individual and/or policy owner perpetually, without disclosure at any predefined policy-related or lifecycle event, as selected by the policy owner or transaction configuration.”
